(19) United States
(12) Patent Application Publication
(10) Pub. No.: US 2013/0255339 A1
(43) Pub. Date: Oct. 3, 2013

(54) PROCESS FOR REDUCING WATER SOLUBLE ELEMENTS USING AN AMENDED ANIMAL MANURE FERTILIZER OR LITTER

(71) Applicant: BOARD OF TRUSTEES OF THE UNIVERSITY OF ARKANSAS, (US)

(72) Inventors: David Zaharoff, Fayetteville, AR (US); Brian E. Haggard, Fayetteville, AR (US); Iain M. Bailey, Fayetteville, AR (US)

(73) Assignee: BOARD OF TRUSTEES OF THE UNIVERSITY OF ARKANSAS, Little Rock, AR (US)

(21) Appl. No.: 13/790,955

(22) Filed: Mar. 8, 2013

Related U.S. Application Data
(60) Provisional application No. 61/619,744, filed on Apr. 3, 2012.

(51) Int. Cl. C05F 3/02

(52) U.S. Cl. CPC C05F 3/02
USPC 71/21

(57) ABSTRACT

The invention relates to process for reducing water soluble elements, namely phosphorus, in animal manure fertilizer and/or litter, namely poultry litter, using chitin or chitosan. The amended fertilizer or litter has useful applications in confined animal production for reducing the water solubility of phosphorous and other trace elements in manure and litter.

### CROSS REFERENCE TO RELATED APPLICATIONS

This application claims the benefit of U.S. Provisional Patent Application Ser. No. 61/619,744, entitled “Process for Reducing Water Soluble Phosphorus in Poultry Litter Using Chitosan,” filed Apr. 3, 2012, which is incorporated herein by reference in its entirety.

### STATEMENT REGARDING FEDERALLY SPONSORED RESEARCH OR DEVELOPMENT

Not Applicable.

### BACKGROUND OF THE INVENTION

1. Field of the Invention

This invention relates generally to a process for reducing water soluble elements, namely phosphorus, using chitin- or chitosan-amended animal manure fertilizer or litter, namely poultry litter.

2. Description of the Related Art.

The amount of water extractable phosphorus in animal manure is directly related to how much phosphorus is lost during rainfall-runoff events. Thus, the use of chemical amendments to reduce water extractable phosphorus has been previously investigated to decrease phosphorus loss in runoff and minimize nonpoint source pollution. Chitin is the second most abundant natural polysaccharide on earth, and is found as the main structural component in crustacean shells. Chitin serves as the chemical precursor to chitosan. Chitosan is an organic molecule, as opposed to a heavy metal salt, that is formed from chitin through the process of chemical deacetylation, which removes some or all of the acetyl groups from each of the carbohydrate monomers and exposes the amino groups. Depending upon the pH of the medium or reacting aqueous solution, the amino groups can become protonated and cause the molecule to become cationic. Chitosan can be characterized by the purity of the sample, the average molecular weight of the polysaccharide chain, and the degree of deacetylation that the chitin underwent upon transformation to chitosan. Chitosan can also be characterized by source: commercial chitosan is usually derived from crab shells, whereas other varieties can be derived from shrimp and crawfish discards.

This combination of cationic and structural flexibility makes chitosan highly reactive with a large spectrum of different chemicals in aqueous solutions. Especially when coupled with an inorganic salt to prevent the molecule from elongating in solution, chitosan shows a good affinity for chelating both anions and cations. Its ability to flocculate solids has been studied most commonly in commercial wastewater treatment applications and manure separation. More recently, chitosan has been used to flocculate algae in streams and even immobilize algae to promote nutrient removal.

The animal industries produce a substantial amount of manure and litter (manure plus bedding specific to the poultry industry), and several states base manure applications to agricultural fields via a phosphorus index on the amount of water extractable phosphorus in the poultry litter. Poultry litter has been used as fertilizer for decades, and historically, poultry litter was land applied at prescribed rates based upon forage nitrogen needs; however, more recently phosphorus content in the litter and soil have guided application rates. These changes in management were prompted by concerns over accelerated eutrophication, where phosphorus has been noted or even assumed to be the factor limiting algal growth. The loss of phosphorus in runoff from land applied-poultry litter is regulated by the amount of water extractable phosphorus, where water extractable phosphorus application rates are positively related to runoff concentrations and loads. The water solubility of phosphorus in poultry litter can be reduced by chemical amendments, and some chemicals also reduce ammonia volatilization during poultry production.

It is therefore desirable to provide a process for reducing water soluble elements, namely phosphorus, in animal manure fertilizer using chitosan.

It is further desirable to provide an animal manure fertilizer and/or litter incorporating chitin or chitosan that has useful applications in confined animal production for reducing the water solubility of phosphorous and other trace elements in poultry litter.

It is further desirable to provide a process for reducing water soluble elements and other trace elements using chitin or chitosan that is beneficial to farmers utilizing animal manure and/or litter as a fertilizer to agricultural fields, allowing more of this organic fertilizer to be spread to meet plant nutrient needs.

It is still further desirable to provide an chitin- or chitosan-amended fertilizer and/or litter that contains a high proportion of nitrogen, which when mixed with animal manure and/or litter can make a more balanced (nitrogen to phosphorus) fertilizer for agricultural fields.

It is yet further desirable to provide a chitin- or chitosan-amended animal manure fertilizer that lowers water extractable phosphorus and increases nitrogen to phosphorus ratios for providing a better, more balanced fertilizer that decreases environmental concerns related to nonpoint source pollution.

### SUMMARY OF THE INVENTION

In general, the invention relates to processes of producing and using a chitin- or chitosan-amended animal manure fertilizer or litter for reducing at least one water soluble element. The processes include amending an animal manure fertilizer or litter with chitin or chitosan to form the amended animal manure fertilizer or litter, providing the amended animal manure or fertilizer for reducing the water soluble element in a plant or agriculture crop, and/or applying the amended animal manure fertilizer or litter to the plant or agriculture crop for reducing the water soluble element. The amended animal manure fertilizer or litter can comprise up to approximately 10% w/w chitin or chitosan, or between approximately 1% and approximately 10% w/w chitin or chitosan, namely approximately 5% w/w chitin or chitosan. Further, the water soluble element can be phosphorus, potassium, calcium, magnesium, sulfur, sodium, iron, manganese, zinc, copper, boron or aluminum, namely phosphorus. Moreover, the amended animal manure fertilizer or litter is poultry litter.

### BRIEF DESCRIPTION OF THE DRAWINGS

FIG. 1 graphically illustrates the results of Experiment 1 on the effects of the treatments on water-extractable phosphorus in poultry litter, where each chemical was applied at 1% by mass based on the mass of poultry litter as is. The treatments are: 1—Control, 2—aluminum sulfate (alum) 1%, 3—chitin from shrimp shells 1% (poly(N-acetyl-1,4,beta-D-glucopyranosamine)), 4—chitosan 1% (poly(D-glucosamine) deacetylated), 5—chitosan 1% (poly(1,4-beta-D-glucosamine)≧75% deacetylated), 6—chitosan from shrimp shells, practical grade. Letters above the bar graph show significant differences (ANOVA, LSD, P<0.05);

FIG. 2 graphically illustrates the results of Experiment 2 on the effects of the treatments on water-extractable phosphorus in poultry litter, where each chemical was applied at 1% by mass based on the mass of poultry litter as is. The treatments are: 1—Control, 2—aluminum sulfate (alum) 1%, 3—chitin from shrimp shells 1% (ploy(N-acetyl-1,4,beta-D-glucopyranosamine)), 4—chitosan 1% (poly(D-glucosamine) deacetylated), 5—chitosan 1% (poly(1,4-beta-D-glucosamine)≧75% deacetylated), 6—chitosan from shrimp shells, practical grade 1%. The letters above the bar graph show significant differences (ANOVA, LSD, P<0.05);

FIG. 3 graphically illustrates the results of Experiment 2 on the effects of the treatments on water-extractable phosphorus in poultry litter, where each chemical was applied at 5% by mass based on the mass of poultry litter as is. The treatments are: 1—Control, 2—aluminum sulfate (alum) 5%, 3—chitin from shrimp shells 5% (ploy(N-acetyl-1,4,beta-D-glucopyranosamine)), 4—chitosan 5% (poly(D-glucosamine) deacetylated), 5—chitosan 5% (poly(1,4-beta-D-glucosamine)≧75% deacetylated), 6—chitosan from shrimp shells, practical grade 5%. The letters above the bar graph show significant differences (ANOVA, LSD, P<0.05); and

FIG. 4 graphically illustrates the results of Experiment 2 on the effects of the treatments on water-extractable phosphorus in poultry litter, where each chemical was applied at 10% by mass based on the mass of poultry litter as is. The treatments are: 1—Control, 2—aluminum sulfate (alum) 10%, 3—chitin from shrimp shells 10% (ploy(N-acetyl-1,4,beta-D-glucopyranosamine)), 4—chitosan 10% (poly(D-glucosamine) deacetylated), 5—chitosan 10% (poly(1,4-beta-D-glucosamine)≧75% deacetylated), 6—chitosan from shrimp shells, practical grade 10%. The letters above the bar graph show significant differences (ANOVA, LSD, P<0.05).

Other advantages and features will be apparent from the following description and from the claims.

### DETAILED DESCRIPTION OF THE INVENTION

The compositions and processes discussed herein are merely illustrative of specific manners in which to make and use this invention and are not to be interpreted as limiting in scope.

While the compositions and processes have been described with a certain degree of particularity, it is to be noted that many modifications may be made in the construction and the arrangement of the structural and function details disclosed herein without departing from the spirit and scope of this disclosure. It is understood that the compositions and processes are not limited to the embodiments set forth herein for purposes of exemplification.

A process for reducing water soluble elements, namely phosphorus, in animal manure fertilizer using chitin or chitosan is disclosed herein. In addition, an animal manure fertilizer and/or litter incorporating chitin or chitosan has useful applications in confined animal production, namely for reducing the water solubility of phosphorous and other trace elements in manure. The chitin- or chitosan-amended animal manure fertilizer or litter significantly decreases the amount of water extractable phosphorus and other water extractable elements relative to poultry litter and even that treated with chitin. The examples below illustrate that the effects of chitin- and chitosan-amended animal manure fertilizers and litters, namely poultry litter, are comparable to aluminum sulfate, which has been shown to reduce phosphorus solubility and ammonia loss during incubations.

### EXAMPLES

The study was performed through a series of three (3) experiments, which examined the effects of chitin and chitosan, as well as aluminum sulfate (alum, Al₂(SO₄)₃)), on ammonia (NH₃) release and water solubility of phosphorus (WEP) and other trace elements.

### Example 1

A control and five (5) separate amendments were used in Example 1, including alum, three (3) grades of chitosan, and coarse-ground chitin (Table 1). A single source of poultry litter was divided into 10 g samples, mixed with treatments (1% w/w as is) and incubated at room temperature for three (3) weeks in closed containers; four (4) replicates were used for each treatment. After incubation, litter samples were analyzed for WEP content and trace element content at the University of Arkansas Agricultural Diagnostic Service Lab. Water extractable elements were determined following standard litter protocols, i.e. 1:100 ratio of dry weight poultry litter to water. The filtrate from the extraction procedure was analyzed for phosphorus (P), potassium (K), calcium (Ca), Magnesium (Mg), sulfur (S), sodium (Na), iron (Fe), manganese (Mn), zinc (Zn), copper (Cu), boron (B), and aluminum (Al) using an ICP-OES. This experiment was to evaluate the effects of chitin and chitosan grades on water extractable elements relative to alum-treated litter and a control (untreated litter) at a low treatment dose (1% w/w).

TABLE 1
Summary of treatments used in experimental series.

| Number | Treatment | Chemical Name | Description |
|---|---|---|---|
| 1 | Control | no chemical | |
| | | amendment | |
| 2 | Alum | aluminum sulfate | |
| 3 | Coarse | chitin from | poly(N-acetyl-1,4,beta-D- |
| | Chitin | shrimp shells | glucopyranosamine) |
| — | Chitosan | — | — |
| 4 | Grade C | chitosan | medium molecular weight; |
| | | | poly(D-glucosamine) |
| | | | deacetylated |
| 5 | Grade B | chitosan from | poly(1,4-beta-D-glucosamine) |
| | | shrimp shells | ≧75% deacetylated |
| 6 | Grade A | chitosan from | practical grade |
| | | shrimp shells | |

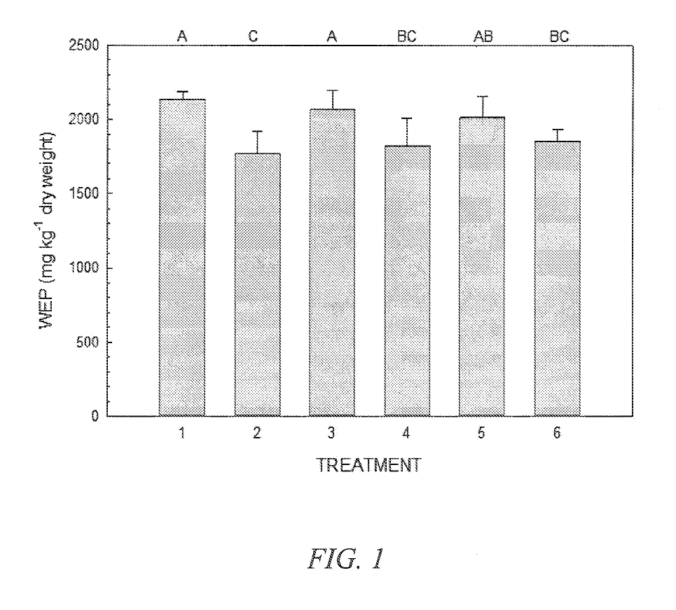

The control samples had the greatest WEP content (2135 mg kg⁻¹ dry weight basis) after incubation, and poultry litter treated with 1% alum showed the least WEP content (1768 mg kg⁻¹; Table 1, FIG. 1). Chitin (3) and chitosan (6; poly(1,4-beta-D-glucosamine) at 1% treatment showed no significant reduction in WEP content versus control and were significantly greater than the poultry litter samples treated by 1% alum. However, there was no significant difference in WEP across the three chitosan treatments at 1% in this first experiment and WEP content in two of the chitosan treatments (4, poly(D-glucosamine) deacetylated, 1826 mg kg⁻¹ and 6, practical grade, 1853 mg kg⁻¹) were not significantly different than WEP in 1% alum-treated poultry litter. The results of Example 1 demonstrate that at least two varieties of chitosan tested (4 and 6) have a significant effect on WEP content versus control.

The results of Example 1 demonstrate that at least two (2) varieties of chitosan tested (4 and 6) have a significant effect on WEP content versus control. Even at 1%, less than the 5% extension recommended application rate of alum, these two (2) varieties showed an average of 14.5% and 13.2% decreases in WEP content compared to untreated litter, respectively. These values are not significantly different from the 17.2% decrease versus control observed in alum-treated samples.

### Example 2

Example 2 was similar to Example 1, except all amendments were applied at 1%, 5%, and 10% (w/w). The amendments were added to the litter at rates typically recommended of alum dosage for the control of NH₃ volatilization (1% w/w) and for control of WEP (5-10% w/w). The same litter source was divided into 5 g samples for analysis, including four (4) replicates for each treatment; amendments and litter were well mixed and then incubated at room temperature for three (3) weeks. Samples were again taken to the Agricultural Diagnostic Service Lab and analyzed for water extractable elements using the protocol described above in relation to Example 1.

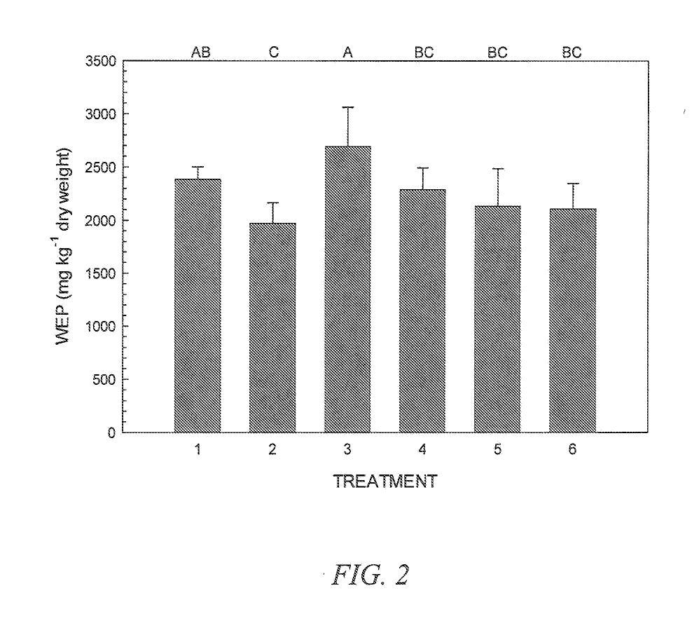

At the 1% w/w treatment rate, the results were not as predictable as those from Experiment 1 (FIG. 2). The WEP content of chitin-treated poultry litter (2689 mg kg⁻¹ dry weight basis) were not significantly different than the control (2382 mg kg⁻¹), and the WEP content in the control poultry litter was not significantly different than the three chitosan treatments at 1%. However, the three (3) chitosan treatments had WEP contents which were not significantly different than the 1% alum treated poultry litter (1971 mg kg⁻¹).

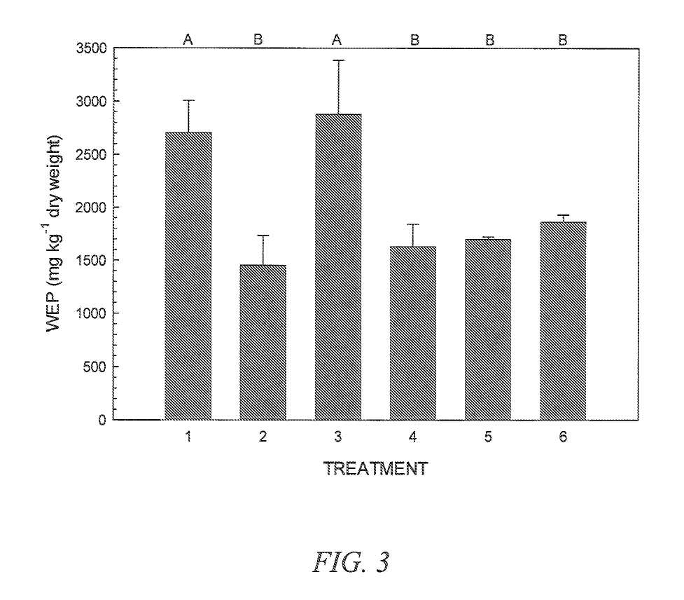

Treatments at 5% w/w showed more pronounced WEP trends than those at 1% w/w (FIG. 3). Treatment with chitin showed no significant difference in WEP content (2875 mg kg⁻¹) versus the control samples (2703 mg kg⁻¹). The three varieties of chitosan showed significantly less WEP extracted than control, however, there was no significant difference between the chitosan-treated grand mean (1729 mg kg⁻¹) and alum-treated mean (1451 mg kg⁻¹).

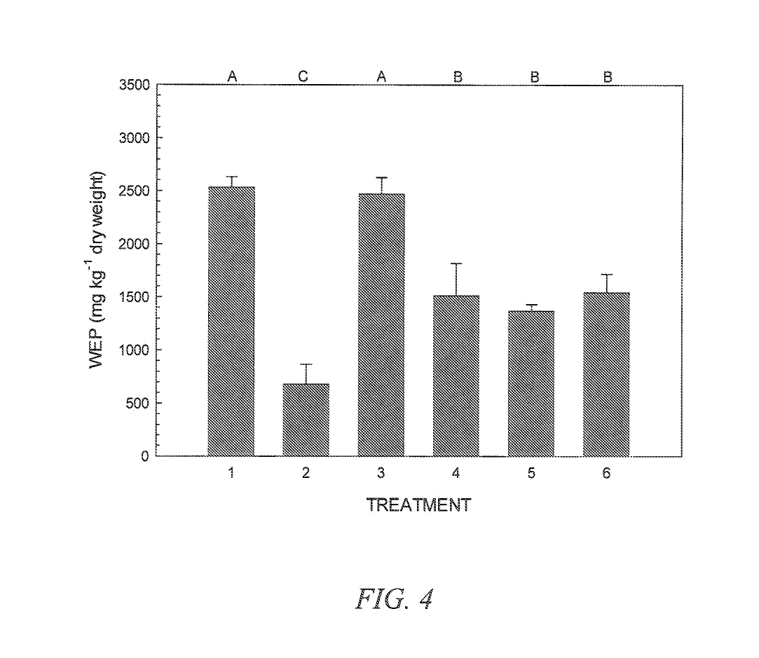

The 10% w/w treatment results differed from those of 5% and 1% (FIG. 4). At 10%, chitin-treated litter WEP levels (2469 mg kg⁻¹) showed no significant difference from control (2528 mg kg⁻¹) and did show significantly greater WEP levels than alum-treated samples (678 mg kg⁻¹). All three chitosan varieties showed significantly less chelation of WEP (1474 mg kg⁻¹) than alum but significantly greater chelation of P than control.

In Example 2, chitosan-treated samples were not significantly different in WEP content than control at 1% w/w treatment; however, these values were also not significantly different from the WEP content decrease observed by alum-treated samples (17.3%). Although chitosan 6, practical grade, showed the closest performance to alum at this rate, the three (3) grades of chitosan did not perform significantly differently compared to each other. Treatment rates at extension recommendations affected the results dramatically for all three (3) varieties of chitosan and control. Chitosan 4, 5, and 6 showed 39.7%, 37.2%, and 31.2% decreases in WEP content, respectively, compared to untreated litter. Again, all three (3) varieties at 5% w/w performed comparably to each other and alum (46.3% decrease compared to control). At 10%, each chitosan variety was not as effective as alum, but all showed decreased WEP compared to untreated poultry litter.

These results of Examples 1 and 2 demonstrate that processed chitin as chitosan, in all three (3) varieties, perform comparably to alum in the chelation of P in poultry litter, especially at 5% w/w treatment. According the results, 5% w/w is the most favorable treatment rate if chitosan were to succeed alum as an amendment to poultry litter to decrease WEP. WEP has been found to control P release during rainfall-runoff studies, and therefore, chitosan-treated poultry litter could have reduced runoff P when land applied.

### Example 3

Example 3 shifted the focus from water extractable elements to effects on NH₃ volatilization, but amendments were only applied at 5% and 10% (w/w) rates. A new litter source was used and analyzed for pH, conductivity, water content, WEP, total N (TN), total P (TP), and other elemental concentrations at the Agricultural Diagnostic Service Lab. The litter was divided into 20 g samples, which were well mixed with each amendment and then transferred to separate Erlenmeyer flasks. A 15 mL vial with 10 mL of deionized water and 4 drops of concentrated hydrochloric acid (HCl) was placed uncovered and upright in each flask. The flasks containing the samples and vials were covered with and were incubated for eight (8) weeks; each treatment included four (4) replicates. Vials were collected and replaced after weeks 1, 2, and 8; vial collection and replacement extended from 2 to 8 weeks, because of initial results. The acidic water in the vials was analyzed for total NH₃—N (as ammonium, NH₄—N) at the Arkansas Water Resources Center Water Quality Lab using a Lachat 8500 following EPA Method 351.2. Following the incubation, the litter was also analyzed for water extractable elements and total N (TN) content.

After week 1, results showed that NH₃ concentrations from the vials in the alum-treated flasks were significantly less than those in the control vial (Table 2). All varieties of chitosan tested showed no significant difference from control except chitosan 6, 10%, which actually had a greater NH₃ concentration than control, unexpectedly. All varieties of chitosan had significantly greater vial NH₃ concentrations compared to alum (5% and 10%).

TABLE 2
Ammonia concentrations in acid trap vials on a weekly basis.

| Treat- | | Week 1 Mean | Week 2 Mean | Week 8 Mean |
|---|---|---|---|---|
| ment | Description | (mg L⁻¹ NH₃) | (mg L⁻¹ NH₃) | (mg L⁻¹ NH₃) |
| 1 | Control | 23.4^{B}* | 34.7^{A,B} | 480.0^{A} |
| 2 | Alum, 5% | 5.3^{C} | 11.3^{C,D} | 171.3^{A,B} |
| 3 | Alum, 10% | 1.6^{C} | 3.9^{D} | 65.7^{B} |
| 4 | Chitosan 6, | 20.5^{B} | 24.3^{B,C} | 249.6^{A,B} |
| | 5% | | | |
| 5 | Chitosan 6, | 37.1^{A} | 41.9^{A} | 370.2^{A,B} |
| | 10% | | | |
| 6 | Chitosan 5, | 23.0^{B} | 29.6^{A,B} | 338.9^{A,B} |
| | 5% | | | |
| 7 | Chitosan 5, | 20.3^{B} | 21.2^{B,C} | 226.8^{A,B} |
| | 10% | | | |
| 8 | Chitosan 4, | 24.8^{B} | 30.8^{A,B} | 453.9^{A} |
| | 5% | | | |
| 9 | Chitosan 4, | 29.3^{A,B} | 30.4^{A,B} | 441.1^{A} |
| | 10% | | | |

*Superscripts denote statistical significance. During a giving sampling week, treatments that share any superscript letters are not statistically different from each other.

Week 2 results showed no significant difference between any chitosan treatment and control; however, chitosan 6, 5% and chitosan 5, 10% both were not significantly different that alum, 5%. Again, chitosan 6, 10% showed greater vial NH₃ concentrations than control, although the difference after week 2 was not significant.

The results of weeks 1 and 2 were similar and suggested that chitosan had no effect on NH3 volatilization from litter, and based on these results, the next vial sampling was set to occur after week 8, a six (6) week incubation. Week 8 results showed no significant difference between control, alum at 5%, and all varieties of chitosan. Alum at 10% showed a significantly less NH₃ concentration than control and both chitosan 4 treatments.

The data from Example 3 demonstrate, because of the significantly reduced NH₃ vial concentrations in the alum-treated samples, that the Example 3 performed as expected. Example 3 also demonstrated that chitin and chitosan do not significantly reduce volatilized NH₃ from poultry litter in these lab experiments. Chitosan, depending on its DD, can range between 5 to 8% TN content, and at the prescribed 10% w/w treatment rate, this could result in up to an approximately 40% increase in the TN content of treated poultry litter assuming untreated litter at 2 to 4% TN content. Thus, the increase in TN may have been caused solely by the native N in the chitosan amine groups, not chitosan's ability to chelate N and prevent NH₃ volatilization; however, chitosan could be combined with alum or other chemicals which reduce litter pH and decrease NH₃ volatilization.

In conclusion, chitosan, in several variations, increased chelation of WEP and TN content compared to untreated litter. Chitosan efficacy is a function of the amount of treatment added to litter and its efficacy compared to alum also varies with treatment level. The invention can also include, but is not limited to, poultry litter treatment to reduce water extractable elements, poultry production bedding to reduce water extractable elements, poultry litter treatment to increase nitrogen content, poultry production bedding to increase nitrogen content, and delivery via acetic acid solution to reduce ammonia emissions.

Whereas, the compositions and processes have been described in relation to the drawings and claims, it should be understood that other and further modifications, apart from those shown or suggested herein, may be made within the spirit and scope of this invention.

What is claimed is:

1. A process for reducing at least one water soluble element using a chitin- or chitosan-amended animal manure fertilizer or litter, said process comprising the steps of:
a. applying said amended animal manure fertilizer or litter to a plant or agriculture crop for reducing said at least one water soluble element.

2. The process of claim 1 further comprising the steps of:
a. amending an animal manure fertilizer or litter with chitin or chitosan to form said amended animal manure fertilizer or litter; and
b. providing said amended animal manure or fertilizer for reducing said at least one water soluble element in a plant or agriculture crop.

3. The process of claim 2 wherein said step of amending said animal manure fertilizer or litter further comprises the step of amending said animal manure fertilizer or litter with up to approximately 10% w/w chitin or chitosan.

4. The process of claim 3 wherein said step of amending said animal manure fertilizer or litter further comprises the step of amending said animal manure fertilizer or litter with between approximately 1% and approximately 10% w/w chitin or chitosan.

5. The process of claim 4 wherein said step of amending said animal manure fertilizer or litter further comprises the step of amending said animal manure fertilizer or litter with approximately 5% w/w chitin or chitosan.

6. The process of claim 1 wherein said at least one water soluble element is selected from the group consisting of phosphorus, potassium, calcium, magnesium, sulfur, sodium, iron, manganese, zinc, copper, boron or aluminum.

7. The process of claim 6 wherein said at least one water soluble element is phosphorus.

8. The process of claim 1 wherein said amended animal manure fertilizer or litter is poultry litter.

9. A process comprising the steps of:
a. amending an animal manure fertilizer or litter with chitin or chitosan to form an amended animal manure fertilizer or litter; and
b. providing said amended animal manure or fertilizer for reducing a water soluble element in a plant or agriculture crop.

10. The process of claim 9 further comprising the step of applying said amended animal manure fertilizer or litter to said plant or agriculture crop for reducing said water soluble element in said plant or agriculture crop.

11. The process of claim 9 wherein said step of amending said animal manure fertilizer or litter further comprises the step of amending said animal manure fertilizer or litter with up to approximately 10% w/w chitin or chitosan.

12. The process of claim 11 wherein said step of amending said animal manure fertilizer or litter further comprises the step of amending said animal manure fertilizer or litter with between approximately 1% and approximately 10% w/w chitin or chitosan.

13. The process of claim 12 wherein said step of amending said animal manure fertilizer or litter further comprises the step of amending said animal manure fertilizer or litter with approximately 5% w/w chitin or chitosan.

14. The process of claim 9 wherein said water soluble element is selected from the group consisting of phosphorus, potassium, calcium, magnesium, sulfur, sodium, iron, manganese, zinc, copper, boron or aluminum.

15. The process of claim 14 wherein said water soluble element is phosphorus.

16. The process of claim 9 wherein said chitosan-amended animal manure fertilizer or litter is poultry litter.

17. A process for producing an amended animal manure fertilizer or litter, said process comprising the steps of:
amending said animal manure fertilizer or litter with between approximately 1% and approximately 10% w/w chitin or chitosan to form said amended animal manure fertilizer or litter; and
wherein said amended animal manure fertilizer or litter reduces at least one water soluble element in a plant or agriculture crop.

18. The process of claim 17 wherein said amended animal manure fertilizer or litter is amended with approximately 5% w/w chitin or chitosan.

19. The process of claim 17 wherein said amended animal manure fertilizer or litter is poultry litter.

20. The process of claim 17 wherein said water soluble element is phosphorus.
